(19) United States
(12) Patent Application Publication
(10) Pub. No.: US 2010/0287856 A1
(43) Pub. Date: Nov. 18, 2010

(54) DOUBLE WINDOW HAVING HORIZONTAL CROSS-VENTILATION FUNCTION

(75) Inventor: Byeong-Hee Yun, Chungcheongbuk-do (KR)

Correspondence Address: David A. Einhorn, Esq.;Baker & Hostetler LLP, 45 Rockefeller Plaza, New York, NY, 10111, US

(73) Assignee: LG HAUSYS , LTD., Seoul (KR)

(21) Appl. No.: 12/810,887

(22) PCT Filed: Dec. 26, 2008
(86) PCT No.: PCT/KR2008/007717

§ 371 Date: Jun. 28, 2010

(30) Foreign Application Priority Data
Dec. 29, 2007 (KR) 10-2007-0141106

(51) Int. Cl. E06B 7/02

(52) U.S. Cl. 52/209; 52/204.593

(57) ABSTRACT

The present invention relates to a double layered window having indoor and outdoor windows. The present invention provides a double layered window having horizontal cross-ventilation means installed at an upper end portion and/or a lower end portion of a vertical window frame so that air may flow in spaces defined between indoor and outdoor windows of each region through the horizontal cross-ventilation means without installing an openable window to all of the regions divided by the vertical window frame or without opening all openable windows.

### TECHNICAL FIELD

The present invention relates to a double layered window having indoor and outdoor windows, and more particularly, to a double layered window configured to induce air flow in a space between indoor and outdoor windows without configuring all the outdoor windows to be openable.

### BACKGROUND ART

Generally, a curtain wall or a double layered window composed of indoor and outdoor windows is installed to an apartment building or a mixed-use residential building. In particular, a double layered window has advantages of ensuring insulation and sound absorption.

FIG. 1 is a schematic view showing a structure of a general double layered window (or a curtain wall). A conventional double layered window includes a window frame 10 fixed to a wall (not shown), sash frames 20 and 30 installed to the window frame 10, and an indoor window 40 and an outdoor window 50 respectively installed to the sash frames 20 and 30, and a predetermined space 60 is defined between the indoor window 40 and the outdoor window 50.

FIG. 2 is a front view of the double layered window in a state where only the outdoor window viewed from the outside is illustrated. The window frame 10 of the double layered window includes upper and lower horizontal window frames 11-1 and 11-2, and a plurality of vertical window frames 12-1, 12-2, 12-3, 12-4 and 12-5 fixed to the upper and lower horizontal window frames 11-1 and 11-2. Such horizontal and vertical window frames allow the window frame 10 to be divided into a plurality of regions to which the sash frames 20 and 30 (see FIG. 1) may be mounted, respectively.

As mentioned above, the outdoor window 50 and the indoor window 40 may be installed to each region formed by the upper and lower horizontal window frames and two vertical window frames, as shown in FIG. 1, and the predetermined space 60 is defined between the indoor window 40 and the outdoor window 50.

Meanwhile, as shown in FIG. 2, in order to ventilate a room, additional openable windows 51 should be installed to upper and lower portions of the outdoor window 50 installed at each region of the window frame, or the outdoor window 50 itself should be installed to be an openable window.

In order to enhance the ventilation performance and energy efficiency, the chimney effect naturally generated by solar rays in the space 60 between the outdoor window 50 and the indoor window 40 has been used, or a blind has been installed.

However, in order to cause the chimney effect in the space between the outdoor window 50 and the indoor window 40, the openable windows 51 should be installed to the upper and lower portions of the outdoor windows 50 in all the regions divided by the vertical window frames 12-1, 12-2, 12-3, 12-4 and 12-5 of the window.

As mentioned above, the openable windows 51 should be installed to the upper and lower portions of all the outdoor windows 50 installed in the regions divided by the vertical window frames 12-1, 12-2, 12-3, 12-4 and 12-5, and openable windows should also be installed to the indoor windows 40.

In the conventional double layered window having the above structure, since the openable windows 51 should be installed to the upper and lower portions of all the outdoor windows 50, there are problems in that production costs are increased and the configuration of the double layered window itself is complicated.

### DISCLOSURE

### Technical Problem

The present invention is conceived to solve the above-mentioned problems, an object of the present invention is to provide a doubled layered window, wherein openings for allowing air to circulate horizontally are formed in upper and lower portions of an inner vertical window frame dividing a window frame so that the air in a space between an outdoor window and an indoor window divided by the vertical window frame may circulate while crossing horizontally, and the aforementioned configuration is employed to dramatically decrease the number of openable windows and maximize the chimney effect and horizontal convection effect occurring in the space between the outdoor window and the indoor window divided by the vertical window frame, thereby optimizing the performance.

### Technical Solution

According to an aspect of the present invention for achieving the objects, there is provided a doubled layered window, which includes a plurality of horizontal window frames, and both outer vertical window frames and a plurality of inner vertical window frames fixed to the horizontal window frames; and outdoor and indoor windows installed to be openable in respective regions defined by the horizontal window frames and the vertical window frames and spaced apart from each other to define predetermined spaces therebetween, wherein a horizontal cross-ventilation means is formed in the vertical window frames so that a space between the indoor and outdoor windows is communicated with a space between the indoor and outdoor windows adjacent thereto with respect to the vertical window frame.

At this time, preferably, the horizontal cross-ventilation means is at least one opening formed in the vertical window frame and allows adjacent two of the spaces to be communicated with each other.

In the double layered window according to one aspect of the present invention, the horizontal cross-ventilation means is formed in the inner vertical window frame. Also, the horizontal cross-ventilation means may be formed in each of upper and lower end portions of the inner vertical window frames.

In the double layered window according to one aspect of the present invention, the horizontal cross-ventilation means allows one space between the indoor and outdoor windows in any one region to be communicated with another space between the indoor and outdoor windows in the adjacent the regions. Preferably, the inner vertical window frames having the horizontal cross-ventilation means formed in upper end portions thereof and the inner vertical window frames having the horizontal cross-ventilation means formed in lower end portions thereof are disposed alternatively.

### Advantageous Effects

As mentioned above, according to a double layered window of the present invention, openings for allowing air to circulate horizontally are formed in upper and lower portions of an inner vertical window frame dividing a window frame, whereby the air in a space between an outdoor window and an indoor window divided by the vertical window frame can circulate while crossing horizontally, and the aforementioned configuration is employed to dramatically decrease the number of openable windows and maximize the chimney effect and horizontal convection effect occurring in the space between the outdoor window and the indoor window divided by the vertical window frame, thereby making it possible to optimize the performance.

### DESCRIPTION OF DRAWINGS

FIG. 1 is a schematic view showing a conventional double layered window (or a conventional curtain wall);

FIG. 2 is a front view of the conventional doubled layered window;

FIGS. 3 and 4 are partial perspective views of a double layered window according to one embodiment of the present invention; and

FIGS. 5 to 7 are front views of the double layered window according to the embodiment of the present invention.

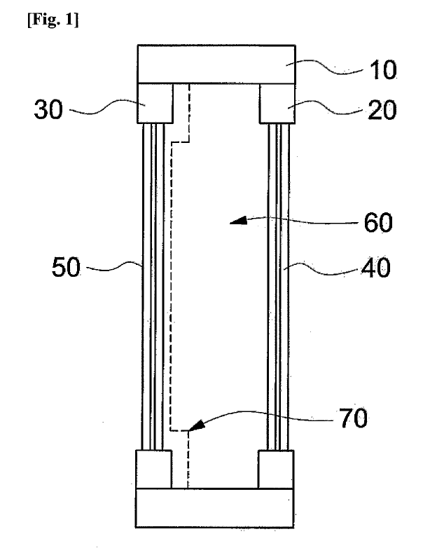

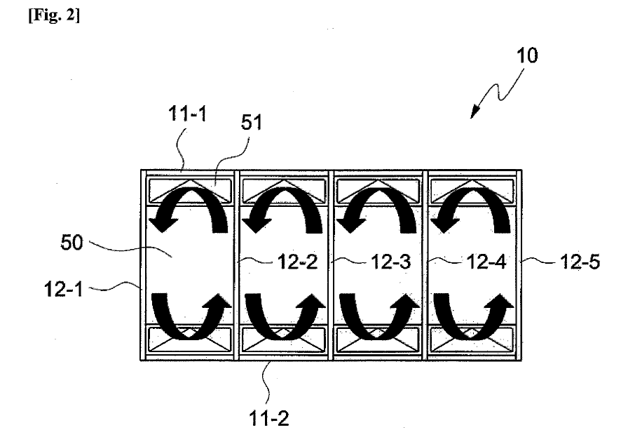

### BEST MODE

Hereinafter, a double layered window according to one embodiment of the present invention will be described in detail with reference to the accompanying drawings. The accompanying drawings are for illustrative purposes and are provided only for explaining the present invention in more detail, and the scope of the present invention is not limited thereto.

A window frame constituting a double layered window according to one embodiment of the present invention comprises upper and lower horizontal window frames and a plurality of vertical window frames fixed to the upper and lower horizontal window frames, and the horizontal and vertical window frames divide the window frame into a plurality of regions to which sash frames are respectively mounted.

An outdoor window and an indoor window are installed in each region formed by the upper and lower horizontal window frames and two vertical window frames, and a predetermined space is defined between the outdoor window and the indoor window.

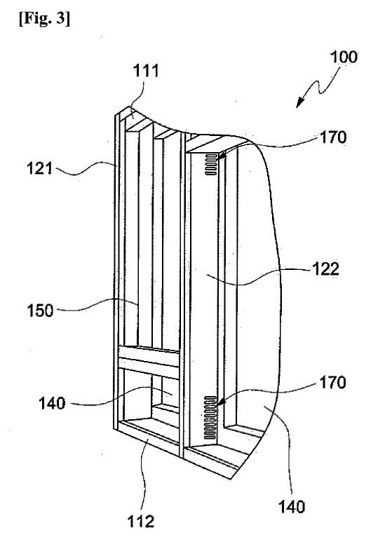

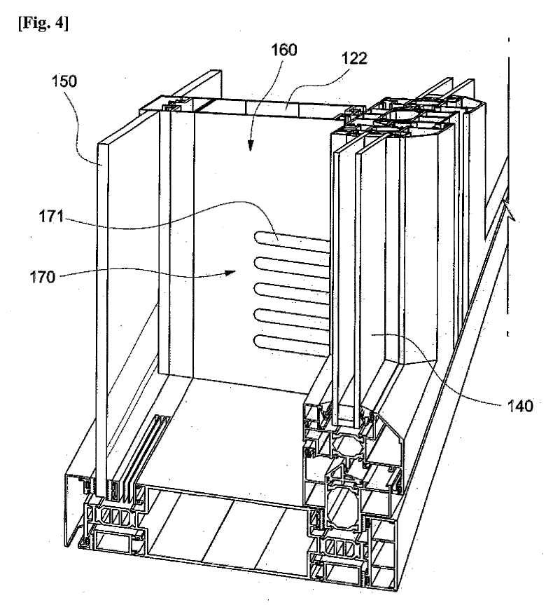

FIGS. 3 and 4 are partial perspective views of the double layered window according to one embodiment of the present invention, in which a horizontal cross-ventilation means is formed. For convenience, only an outermost vertical window frame and any one inner vertical window frame are illustrated. Also, an outdoor window is not depicted in a right side portion of FIG. 3.

Here, a horizontal cross-ventilation means 170 is formed in an inner vertical window frame 122 except for outermost vertical window frames 121 of the doubled layered window. The horizontal cross-ventilation means 170 allows spaces 160 defined at both sides of the vertical window frame 122 (i.e., spaces defined between indoor windows 140 and outdoor windows 150) to be communicated with each other.

That is, the external air introduced into any one of the spaces may be introduced into an adjacent space through the horizontal cross-ventilation means 170. Thus, in a case where an openable window is installed to any one of the outdoor windows, or even in a case where openable windows are installed to all the outdoor windows and only one of the openable windows is open, the air introduced from the outside may be introduced to the adjacent spaces through the horizontal cross-ventilation means 170.

Since the air in every space 160 may circulate by the horizontal cross-ventilation means, openable windows need not be installed to upper and lower portions of every space 160 between indoor and outdoor windows contrary to a conventional doubled layered window. Also, although an openable window is installed to a sash window corresponding to any one of the plurality of spaces 160, the present invention may ensure the existing chimney effects.

Meanwhile, the horizontal cross-ventilation means 170 in the inner vertical window frame 122 has no limitation in its shape, but may comprise a plurality of slit-type openings 171, as shown FIGS. 3 and 4, or a single opening with a large area.

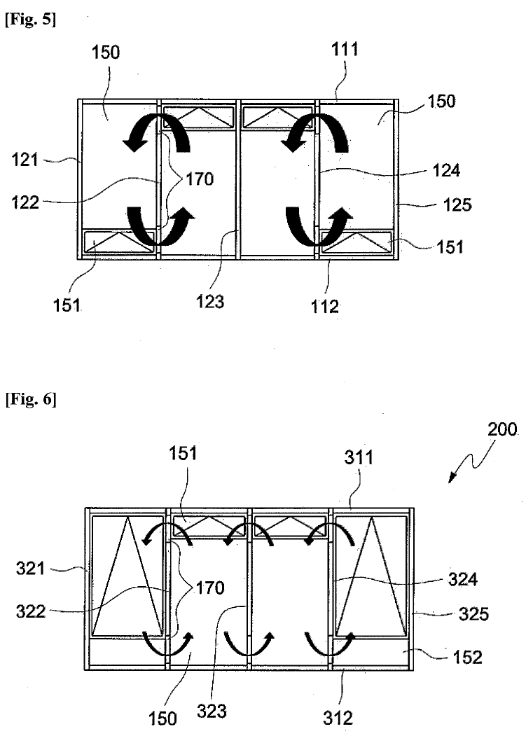

FIGS. 5 to 7 illustrate air flow in a double layered window in which the horizontal cross-ventilation means is formed in the inner vertical window frame, wherein only an outdoor window is depicted for convenience.

Referring to FIG. 5, in the double layered window according to one embodiment of the present invention, the horizontal cross-ventilation means 170 illustrated in FIG. 3 is formed in each of upper and lower portions of any one vertical window frame 122, and no horizontal cross-ventilation means 170 may be formed in an adjacent vertical window frame 123.

In the double layered window so configured, air may circulate between two spaces (i.e., spaces between outdoor and indoor windows) in the two adjacent regions through the horizontal cross-ventilation means 170.

If an openable window 151 is formed only in an upper or lower portion of the outdoor window 150 in each region, external air introduced through the openable window 151 may be circulated in the spaces of the two regions through the horizontal cross-ventilation means 170.

FIG. 6 shows that the horizontal cross-ventilation means is installed to each of upper and lower portions of all of vertical window frames 322, 323 and 324, except for the outmost vertical window frames 321 and 325 of the window frame 200.

In this configuration, the spaces (between the outdoor and indoor windows) of all regions are communicated with each other through the horizontal cross-ventilation means, and thus, air in the space of any one region may circulate in the spaces of all the regions.

If an openable window 151 is formed only in an upper or lower portion of the outdoor window 150 in any one region, external air introduced into any one space through the openable window 151 may be circulated in all of the spaces through the horizontal cross-ventilation means 170.

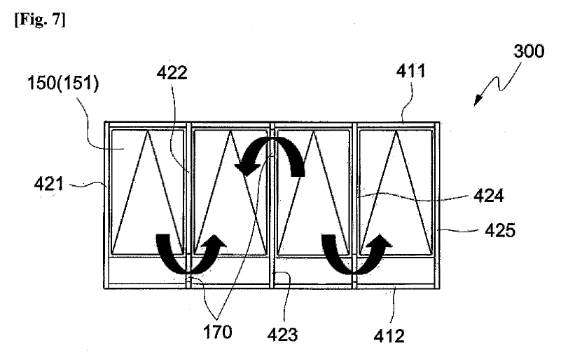

FIG. 7 shows that the horizontal cross-ventilation means 170 is formed in each of a lower portion of any one vertical window frame 422 or 424 and an upper portion of an adjacent vertical window frame 423.

Even in this configuration, the spaces (between the outdoor and indoor windows) of all regions are communicated with each other through the horizontal cross-ventilation means, and thus, air in the space of any one of the regions may circulate in the spaces of all the regions.

In various applications implemented in FIGS. 5 to 7, the indoor window may be formed as one openable window or divided into two areas among which one area is formed as a fixed window and the other area is formed as an openable window.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and appended claims. In addition to variations and modifications in the component parts and/or arrangements, alternative uses will also be apparent to those skilled in the art.

1. A doubled layered window, comprising:
a plurality of horizontal window frames, and both outer vertical window frames and a plurality of inner vertical window frames fixed to the horizontal window frames; and
outdoor and indoor windows disposed in respective regions defined by the horizontal window frames and the vertical window frames and spaced apart from each other to define certain space therebetween,
wherein a horizontal cross-ventilation means is formed in the vertical window frames so that one space between the indoor and outdoor windows in any one region is communicated with another space between the indoor and outdoor windows in the adjacent regions through the horizontal cross-ventilation means.

2. The double layered window as claimed in claim 1, wherein the horizontal cross-ventilation means is at least one opening formed in the vertical window frame and allows adjacent two of the spaces to be communicated with each other.

3. The double layered window as claimed in claim 1, wherein the horizontal cross-ventilation means are formed in upper and lower end portions of the inner vertical window frames.

4. The double layered window as claimed in claim 1, wherein the inner vertical window frames having the horizontal cross-ventilation means formed in upper end portions thereof and the inner vertical window frames having the horizontal cross-ventilation means formed in lower end portions thereof are disposed alternatively.
